(19) United States
(12) Patent Application Publication
(10) Pub. No.: US 2026/0299338 A1
(43) Pub. Date: Oct. 1, 2026

(54) HIGH-SPEED METASURFACE PROGRAMMING SYSTEM

(71) Applicant: Neurophos Inc., Austin, TX (US)

(72) Inventors: Yanning Lu, Austin, TX (US); Donald M. Bartlett, Fort Collins, CO (US); Andrew J. Traverso, Durham, NC (US)

(73) Assignee: Neurophos Inc., Austin, TX (US)

(21) Appl. No.: 19/631,522

(22) Filed: Mar. 27, 2026

Related U.S. Application Data
(60) Provisional application No. 63/780,138, filed on Mar. 28, 2025.

(51) Int. Cl. G02F 1/133; G06E 3/00

(52) U.S. Cl. CPC G02F 1/13306; G06E 3/00

(57) ABSTRACT

Various embodiments of systems and methods are described for high-speed metasurface programming, especially for use in optical computing. The system enables precise voltage control over a large-scale metasurface matrix using an array of digital-to-analog converters (DACs) for programming discrete metasurface cells. A row driver array generates row-enable signals for row-by-row programming. A pixel sampler matrix includes switches and capacitors to perform sample-and-hold operations to maintain voltage levels with reduced refresh rate requirements. A common mode voltage switching circuit may be used to attain a zero average DC voltage across metasurface cells to reduce or minimize charge leakage. A leakage-reducing switch driver may drive subthreshold biasing to minimize transmission gate leakage. Independently controlled regions or quadrants may be used to reduce parasitic capacitance and/or enhance signal integrity.

### CROSS-REFERENCE TO RELATED APPLICATIONS

This application claims the benefit under 35 U.S.C. 119(e) of U.S. Provisional Patent Application No. 63/780,138, filed Mar. 28, 2025, and titled “HIGH-SPEED METASURFACE PROGRAMMING SYSTEM,” which is hereby incorporated herein by reference in its entirety.

### BACKGROUND

Optical computing systems may process signals using optical elements.

### BRIEF SUMMARY

According to some aspects of the present disclosure, an optical computing device comprises: a substrate; a metasurface array arranged on the substrate, the metasurface array including a plurality of metasurface cells; and circuitry configured to program metasurface cells of the plurality of metasurface cells of the metasurface array.

In some embodiments, the plurality of metasurface cells of the metasurface array includes a first metasurface cell; wherein the circuitry includes a first programming circuit configured to apply a first programming value to the first metasurface cell.

In some embodiments, the first programming circuit includes: a first digital-to-analog converter (DAC) configured to generate the first programming value; and a first transmission gate, including a first transistor and a second transistor, the first transmission gate configured to apply the first programming value to the first metasurface cell based on one or more enable signals.

In some embodiments, the circuitry further includes a row driver configured to generate the one or more enable signals.

In some embodiments, the circuitry is configured to apply subthreshold biasing signals to the first transistor and the second transistor to close the first transmission gate.

In some embodiments, the circuitry further includes: a first hold capacitor, configured to hold the first metasurface cell at the first programming value when the first transmission gate is closed.

In some embodiments, the circuitry further includes: a common mode driver configured to apply a common mode voltage to the first metasurface cell when the first programming circuit applies the first programming value to the first metasurface cell.

In some embodiments, the optical computing device further includes: a second programming circuit, configured to apply a second programming value to the first metasurface cell of the metasurface array.

In some embodiments, the common mode driver is configured to generate the common mode voltage such that the common mode voltage has a periodic signal.

In some embodiments, each metasurface cell of the plurality of metasurface cells of the metasurface array is coupled to the circuitry such that each metasurface cell is coupled to a first programming circuit configured to generate a first cell voltage, a second programming circuit configured to generate a second cell voltage, and a common mode driver configured to generate a time-varied common mode voltage.

In some embodiments, each metasurface cell of the plurality of metasurface cells of the metasurface array is coupled to the circuitry such that each metasurface cell is coupled to a first programming circuit configured to generate a first cell voltage, a second programming circuit configured to generate a second cell voltage, and a third programming circuit configured to generate a third cell voltage.

In some embodiments, each metasurface cell of the plurality of metasurface cells of the metasurface array is associated with a respective row and a respective column; and the circuitry is configured to program each metasurface cell using a respective row signal and a respective column signal.

In some embodiments, each metasurface cell of the plurality of metasurface cells of the metasurface array includes: a first resonator; a second resonator; and a dielectric material disposed between the first resonator and the second resonator.

In some embodiments, the dielectric material includes a liquid crystal mixture.

According to some aspects of the present disclosure, a method of controlling optical properties of a metasurface array including a plurality of metasurface cells comprises: selecting a first metasurface cell of the plurality of metasurface cells of the metasurface array; generating a first programming value; and applying the first programming value to the first metasurface cell.

In some embodiments, the method further includes: generating a second programming value; and applying the second programming value to the first metasurface cell.

In some embodiments, generating the first programming value includes: generating a first voltage using a first digital-to-analog circuit (DAC); and applying the first voltage to the first metasurface cell of the plurality of metasurface cells of the metasurface array using a transmission gate including a first transistor and a second transistor.

In some embodiments, applying the first voltage to the first metasurface cell using the transmission gate includes: applying one or more enable signals to the first transistor and the second transistor using a row driver.

In some embodiments, the method further includes: retaining a programmed voltage using a hold capacitor.

In some embodiments, the method further includes: applying a common mode signal to the first metasurface cell of the plurality of metasurface cells of the metasurface array.

According to some aspects of the present disclosure, an optical computing system includes: an integrated circuit configured to generate first control signals; an optical computing device coupled to the integrated circuit, including: a metasurface array; and circuitry configured to program the metasurface array based on the first control signals transmitted by the integrated circuit; a photonic transmitter configured to transmit first optical signals to the metasurface array; and a photonic receiver, configured to receive second optical signals from the metasurface array.

In some embodiments, the integrated circuit is further configured to generate second control signals, the photonic transmitter configured to transmit the first optical signals to the metasurface array based on the second control signals; and the integrated circuit is further configured to perform at least one calculation based on the second optical signals received from the metasurface array by the photonic receiver.

In some embodiments, the optical computing system further includes: a printed circuit board (PCB), wherein the optical computing system is disposed on the PCB; and an interposer positioned between the integrated circuit and the PCB.

In some embodiments, the metasurface array includes a plurality of metasurface cells; and each metasurface cell of the plurality of metasurface cells of the metasurface array is coupled to a first programming circuit of the circuitry, a second programming circuit of the circuitry, and a common mode driver of the circuitry.

In some embodiments, the circuitry configured to program the metasurface array includes a first DAC and a second DAC, wherein the first and second DACs are configured to write programming values to two or more metasurface cells of the metasurface array simultaneously.

The foregoing summary is not intended to be limiting. Moreover, it should be appreciated that aspects described herein may be implemented individually or in any combination.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1 is a cross-sectional view of a metasurface programming structure, according to a non-limiting embodiment of the present technology.

FIG. 2 is a direct-modulated non-coherent optical vector matrix multiplier, according to a non-limiting embodiment of the present technology.

FIG. 3 is a timing diagram for high-speed row-by-row programming with digital-to-analog converter (DAC) output synchronized with row-enable signals, according to a non-limiting embodiment of the present technology.

FIG. 4 is a graph showing voltage values of DAC output and common mode voltage, according to a non-limiting embodiment of the present technology.

FIG. 5 is a graph showing voltage values of DAC output and common mode voltage using an alternative approach for common mode voltage switching with periodic polarity inversion, according to a non-limiting embodiment of the present technology.

FIG. 6A is a circuit diagram of a pixel sampler cell, according to a non-limiting embodiment of the present technology.

FIG. 6B is a circuit diagram of an alternative pixel sampler cell, according to a non-limiting embodiment of the present technology.

FIG. 7A is the metasurface cell of FIGS. 6A-6B with a dielectric material between two resonators, according to a non-limiting embodiment of the present technology.

FIG. 7B is a graph showing liquidus/solidus lines (estimated Tₘᵢₓ) corresponding to Xₐ(solid line) and X_{b} (dashed line), according to some embodiments described herein. The Eutectic point is shown as the intersection (circle), according to a non-limiting embodiment of the present technology.

FIG. 8 shows various molecular structures of liquid crystal mesogens that may be used to formulate high-birefringence liquid crystal mixtures, according to a non-limiting embodiment of the present technology.

FIG. 9 is a schematic diagram of an illustrative computer system, which may be used to implement some aspects of the technology described herein.

FIG. 10 illustrates a block diagram of stacked layers of the optical vector matrix multiplier of FIG. 2, according to a non-limiting embodiment of the present technology.

### DETAILED DESCRIPTION

According to aspects of the disclosure, there is provided a metasurface for performing optical computing. In some embodiments, the metasurface may comprise a metasurface array. A metasurface array may include a plurality of metasurface elements. For example, the metasurface array may comprise a plurality of metasurface pixels. Elements of the metasurface array (e.g., metasurface pixels) may be controllable. For example, each respective element of the metasurface array may be individually controllable. For example, an element may be controlled by programming a value to the element.

The inventors have recognized there is an increasing demand for compute, for example due to increasing adoption of Artificial Intelligence (AI). However, operating these AI systems (e.g., using data centers) consumes a significant portion of global energy production due to the consumption of high-speed processors. Future AI performance relies on maximizing compute density (operations per square millimeter of silicon) and manufacturing efficiency (cost per square millimeter). One strategy for optimizing matrix operations, central to AI workloads, is the use of systolic arrays to process batches of data in a 2D grid of processing elements (PEs). However, digital architectures that use systolic arrays plateau in efficiency around 100-200 elements due to power consumption of the digital systolic arrays. Implementing systolic arrays with analog architectures improves power efficiency, but analog electronic implementations (e.g., resistors and capacitors) may suffer from signal propagation RC delays proportional to area, resulting in clock speeds which are orders of magnitude slower than those needed to compete with digital arrays.

The inventors developed a technology that overcomes the challenges of conventional digital computers, as well as analog systolic array execution by leveraging optical computing, wherein signals propagate at the speed of light. Optical computing is not encumbered by RC delays, enabling the implementation of analog systolic arrays at high-speed with high energy efficiency.

An optical computing system may process optical signals based on programmed elements of a metasurface array. For example, when an element of the metasurface array is programmed to have a first value, the element may have a first set of optical properties. When the element is programmed to have a second value, the element may have a second set of optical properties that is different from the first set. In some embodiments, the first and second sets of optical properties may comprise different complex refractivities of the elements. Because the optical properties of the elements affect how light travels within the elements, an optical computing system may program different values to the elements to control how light travels through the metasurface array. By controlling how light travels through the metasurface array, the optical computing system may perform calculations using the metasurface. For various calculations, taking advantage of the manner in which light travels through the metasurface array, an optical commuting system may perform more efficient and/or faster calculations than can be performed using conventional digital computing systems.

A metasurface may be arranged on a substrate. For example, a metasurface may be disposed on a substrate or formed from at least a portion of a substrate. In various embodiments, a metasurface comprises a two-dimensional material. In some embodiments, the metasurface may be an engineered material. Furthermore, a metasurface may be arranged in an array (e.g., a two-dimensional array of rows and columns). In some embodiments, elements may be arranged along a row or column. For example, each element of a row or column may be aligned with each other element of the row or column. In some embodiments, at least some elements of a row or column may be offset from at least some other elements of the row or column.

Each element in the metasurface may be individually controllable. For example, each element may be configured to receive a programming value. The programming value may determine optical properties of the element. As such, by programming different values to different elements, the optical properties of the metasurface as a whole may be controlled. In some embodiments, each element may comprise a subwavelength-scale element. By controlling the elements of the metasurface, the metasurface may perform dynamic wavefront shaping, phase modulation, and/or polarization control through localized electromagnetic responses. In some embodiments, a metasurface cell comprises an individual programmable element within the metasurface matrix. For example, each cell may comprise a pixel of an array formed by the metasurface. Each cell may be selectively tuned to exhibit different optical properties, such as phase shift, reflectance, transmission, complex refractivity, or the like. For example, each metasurface cell may be dynamically controlled by one or more applied voltages. In various embodiments, voltages applied to each metasurface cell may cause the cell to exhibit different refractive indices, complex refractivities, phase responses or other optical properties. By controlling a plurality of such cells arranged in an array, the optical computing system may reconfigure the array to perform optical computations. In some embodiments, the system comprises a controller for controlling the cells. For example, the controller may comprise circuitry. The controller is configured to adjust one or more voltages applied to each cell to dynamically alter the optical behavior of each cell, and thus, the metasurface. As described herein, the metasurface may be tuned and controlled as part of an optical computing system configured to perform complex computational tasks with high speed and efficiency.

According to aspects of the disclosure, there is provided a high-speed metasurface programming system. The metasurface system includes components configured to perform rapid and precise voltage programming of metasurface cells for optical computing applications. The presently described systems and methods allow the system to perform optical computations that outperform conventional digital computing systems with regards to speed and energy efficiency. In various embodiments, the systems and methods described herein may perform multiple optical computations in parallel, further increasing the efficiency and speed of the system. For example, an optical computing system may perform parallel wavefront processing rather than serial electronic operations as are performed in conventional digital systems.

The inventors have recognized and appreciated that optical computation systems having metasurfaces may use fast, large-scale voltage programming across an extensive array of metasurface cells. Therefore, according to various embodiments of the disclosure, a high-speed metasurface programming system may include a circuit architecture configured to perform GHz-speed voltage updates across a metasurface matrix. In one example, the system includes an array of digital-to-analog converters (DACs). The DACs may operate in parallel. Each DAC may convert digital input data into analog voltage values that are applied to program respective metasurface cells. The system may also include a plurality of row drivers. Each row driver array may be configured to selectively activate specific rows of metasurface cells. For example, a row driver may activate rows so that one row is written at a time by one or more DACs. The system may also include a pixel sampler matrix. The pixel sampler matrix may include an array of individual pixel sampler cells. Circuitry of the pixel sample matrix may be configured to maintain voltage programmed to a cell. For example, the pixel sample matrix may include integrated sample-and-hold circuitry configured to maintain programmed voltages of respective metasurface cells for a target time period. The target time period may be provided to reduce the refresh rates of the system and/or reduce overall power consumption of the system.

The inventors have further recognized and appreciated that during programming, metasurface cells may exhibit charge leakage. Charge leakage may cause voltage levels to degrade over time, which may reduce the efficiency of an optical computing system. According to various embodiments, systems described herein may include a switch driver configured to reduce leakage. For example, the switch driver may be configured to apply subthreshold biasing to the transmission gates of the pixel sampler matrix. As such, the switch driver may be a leakage-reducing switch driver configured to reduces leakage current. Reducing the leakage current may extend the hold time of the voltage stored on each metasurface cell, which in turn may increase the efficiency of the optical computing system.

In various embodiments, the system may apply common-mode voltages to cells of the metasurface. For example, the system may perform common-mode voltage switching to apply an average DC voltage across each metasurface cell of zero or approximately zero. Maintaining the average DC voltage around zero prevents charge buildup and device degradation over time, improving device lifespan. Using the DACs to generate differential voltages could increase circuit complexity of the system. Instead, the presently described systems and methods may periodically switch the polarity of the common-mode voltage, thus reducing system complexity. The switched common-mode voltage polarity may thus prevent charge buildup without increasing the DAC voltage swing requirement.

In various embodiments, the system controls a partitioned metasurface architecture. For example, the metasurface matrix may be divided into independently controlled regions (e.g., four quadrants, two halves, three thirds, six regions, etc.). The system may include controllers for each region. Providing controllers for each region may reduce parasitic capacitance, improve signal integrity, and reduce crosstalk and/or other interference. Partitioning the metasurface also provides for scalability of the metasurface. For example, the same metasurface programming configuration may be used for different metasurface sizes and configurations, increasing the efficiency of fabricating or designing a metasurface.

In various embodiments, the system may include a combination of one or more of the subsystems and features described above. A system may include all the features described above to provide a scalable and efficient method for dynamically programming large metasurfaces at high speed. Various embodiments of the systems described herein include high-speed DACs, row drivers, sample-and-hold circuitry, leakage-reducing switch drivers, common-mode voltage switching, and partitioned metasurfaces with respective controllers. As described herein, the presently described systems and methods provide precise voltage control, extended voltage retention, and low power operation, thus providing high speed and high efficiency optical computing systems.

Metasurfaces described herein may include various configurations of metasurface cells. For example, a metasurface cell may include two resonators that are spaced apart from one another. For example, the spacing may be less than a wavelength, with the wavelength being within an operational bandwidth. The dimensions of the resonators may be provided based on a target response of the metasurface. The metasurface cell may further include a voltage-tunable dielectric material between the resonators. For example, the refractive index, phase response, complex refractivity, or other optical properties of the metasurface cell may be dynamically adjusted by applying a voltage differential to the cell. For example, the voltage may be applied across the voltage-tunable dielectric between the two resonators.

Existing computing systems, methods, and devices may be used in combination with the presently described systems and methods. Some of the infrastructure that may be used with embodiments disclosed herein is already available, such as general-purpose computers, computer programming tools and techniques, digital storage media, and communication links. A computing device or controller may include a processor, such as a processor, a microprocessor, a microcontroller, logic circuitry, or the like.

A processor may include a special-purpose processing device, such as application-specific integrated circuits (ASIC), programmable array logic (PAL), programmable logic array (PLA), programmable logic device (PLD), field programmable gate array (FPGA), or other customizable and/or programmable device. The computing device may also include a machine-readable storage device or memory device, such as non-volatile memory, static RAM, dynamic RAM, ROM, CD-ROM, disk, tape, magnetic, optical, flash memory, or other machine-readable storage medium. For example, a memory or storage device may be a non-transitory computer-readable storage medium having instructions encoded thereon, that when executed by a processor or controller, cause the processor or controller to carry out one of the methods or steps described herein. Various aspects of certain embodiments may be implemented using hardware, software, firmware, or a combination thereof.

The components of the disclosed embodiments, as generally described and illustrated in the figures herein, could be arranged and designed in a wide variety of different configurations. Furthermore, the features, structures, and operations associated with one embodiment may be applicable to or combined with the features, structures, or operations described in conjunction with another embodiment. In many instances, well-known structures, materials, or operations are not shown or described in detail to avoid obscuring aspects of this disclosure.

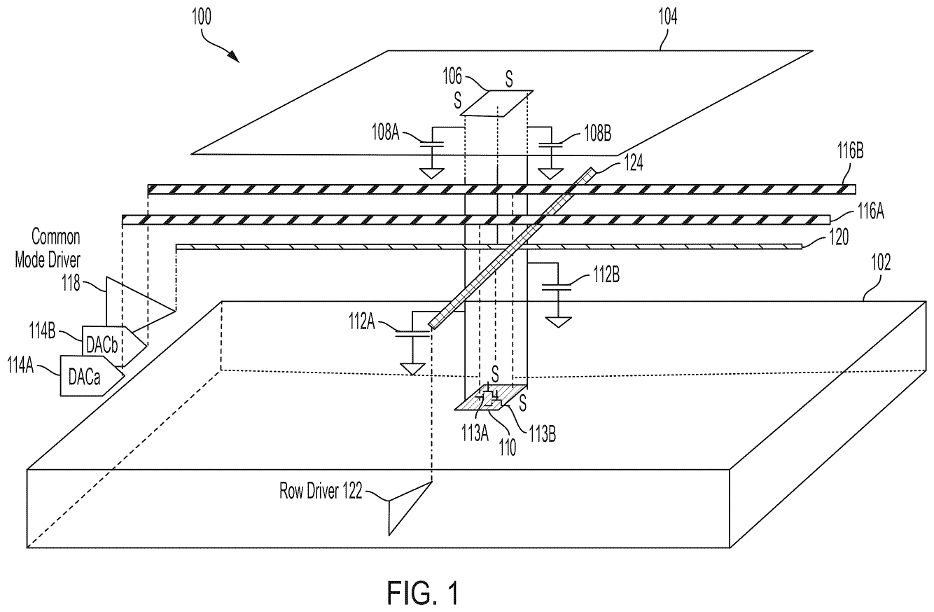

FIG. 1 is a cross-sectional view of a metasurface programming structure 100, according to a non-limiting embodiment of the present technology. The metasurface programming structure 100 includes a substrate 102. A metasurface array 104 is arranged on the substrate 102. For example, a component that is arranged on the substrate may be disposed on the substrate 102, may be formed from at least a portion of the substrate 102, or may be otherwise physically coupled to the substate. The metasurface array 104 includes a plurality of metasurface cells 106. The metasurface cells may be arranged in an array. For example, the array may have rows and columns, with cells arranged along the rows and columns. Each metasurface cell may comprise a metasurface pixel. For example, each metasurface pixel may be controllable (e.g., individually controllable) by circuitry of the metasurface programming structure 100. Each metasurface pixel may be configured to receive a programming value, with the programming value adjusting optical properties of the pixel.

Each metasurface cell may be connected to first-type capacitors 108. A plurality of pixel samplers 110 may be arranged on the substrate 102. For example, each pixel sampler may be coupled with a respective metasurface cell 106. The pixel samplers include second-type capacitors 112 and switching elements 113. A plurality of digital-to-analog converters (DACs) 114 are arranged on the substrate 192. The DACs may be configured to communicate with cells of the metasurface programming structure 100 via first metal interconnect layers 116. A common mode driver circuit 118 (e.g., common mode driver) is arranged on the substrate. The common mode driver circuit is configured to communicate with cells of the metasurface programming structure 100 via a second metal interconnect layer 120. A row driver circuit 122 is arranged on the substrate. The row driver circuit 122 is configured to cause communications to be applied to the cells of the metasurface programming structure 100 via a third metal interconnect layer 124.

As shown, the metasurface array 104 includes the array of metasurface cells 106 (e.g., programmable metasurface cells), each measuring approximately S×S. S may be a value between approximately 5 μm and 20 μm or between approximately 2 μm and 100 μm, (e.g., 5 μm×5 μm, 10 μm×10 μm.). In other embodiments, the programmable metasurface cells 106 may not be square (e.g., rectangular, hexagonal, circular, or oval). Various sizes and dimensions may be utilized depending on the target application. For example, a denser metasurface with smaller metasurface cells may be utilized in various embodiments.

The metasurface cells 106 are configured to interact with incident optical signals. A voltage may be applied to one or more metasurface cells 106 to modify the optical properties (e.g., phase and/or reflectance) of the metasurface cells. The system may apply voltages and/or store the voltage using the first capacitors 108 connected to the metasurface cells 106. In the embodiment shown in FIG. 1, one metasurface cell 106 is illustrated. The illustrated metasurface cell 106 is connected to a first first-type capacitor 108A and a second first-type capacitor 108B. In other embodiments, one metasurface cell 106 may include only one first type capacitor 108. In yet other embodiments, one metasurface cell may include three or more first-type capacitors 108.

Pixel samplers 110 may include a control structure to control voltage application to the metasurface cells 106. The second-type capacitors 112 and the switching elements 113 may be configured to maintain a programmed voltage for a target period of time. The switching elements 113 may be configured to perform a sample-and-hold function that maintains a stable voltage over a target period of time to reduce refresh cycles. Reducing refresh cycles may improve system efficiency. In various embodiments, the control structure may be positioned beneath the corresponding metasurface cell 106. The control structure may be positioned to apply voltages to the respective metasurface cell 106. For example, the control structure may be integrated directly beneath the cells in the substrate. By integrating control circuits directly beneath the metasurface cells 106, interconnect lengths and/or reduce parasitic capacitance may be reduced. Reducing interconnect length and parasitic capacitance may enhance speed of the metasurface programming structure 100.

Each metasurface cell 106 may be arranged having a respective pixel sampler 110. A one-to-one arrangement with a pixel sampler 110 for each metasurface cell 106 may provide a dedicated charge storage mechanism for each metasurface cell 106. Providing dedicated charge storage for each cell may reduce and/or eliminate crosstalk between adjacent metasurface cells. For example, the dimensions of the pixel sampler 110 (e.g., metasurface footprint) may approximately correspond to dimensions of the metasurface cell 106. In other embodiments, the pixel sampler 110 dimensions may be larger or smaller than the dimensions of the metasurface cell 106.

The second-type capacitors 112 may be configured to store the programmed voltages for respective cells. A second-type capacitor 112 may be arranged within the footprint (e.g., pixel sampler 110) of each metasurface cell. In some embodiments, the second-type capacitors 112 are arranged in a different layer of the metasurface programming structure 100 than the pixel sampler 110. The second-type capacitors 112 may be configured to perform precise voltage retention for cells. Voltage retention may stabilize programmed values of the cells and minimize charge leakage from the cells. In the embodiment of FIG. 1, the control structure of the pixel sampler 110 includes a first second-type conductor 112A, a second second-type conductor 112B, a first switching structure 113A, and a second switching structure 113B. In other embodiments, the control structure may include more or fewer than two second-type capacitors 112 and/or switching elements 113. In yet other embodiments, the control structure may include more or fewer second-type capacitors 112 relative to switching elements 113. In various embodiments, the second-type capacitors 112 comprise metal-oxide-metal (MoM) capacitors or other types of capacitors.

The pixel samplers 110 may be configured to act as an interface between the DACs 114 and the metasurface cells 106. The pixel samplers 110 may do so by forming connections (e.g., electrical connections) with the first metal interconnect layers 116, wherein signals generated by the DACs 114 are related to the pixel samplers 110 through the first metal interconnect layers 116. As shown, a first DACa 114A is connected to a first metal interconnect sub-layer 116A of the first metal interconnect layer 116 and a second DACb 114B is connected to a second metal interconnect sublayer 116B of the first metal interconnect layer 116. In some embodiments, the first and second sub-layers 116A and 116B may be arranged as a single layer or as multiple layers of the first metal interconnect layer 116. In some embodiments, the metasurface programming structure 100 may include more or fewer than two DACs 114.

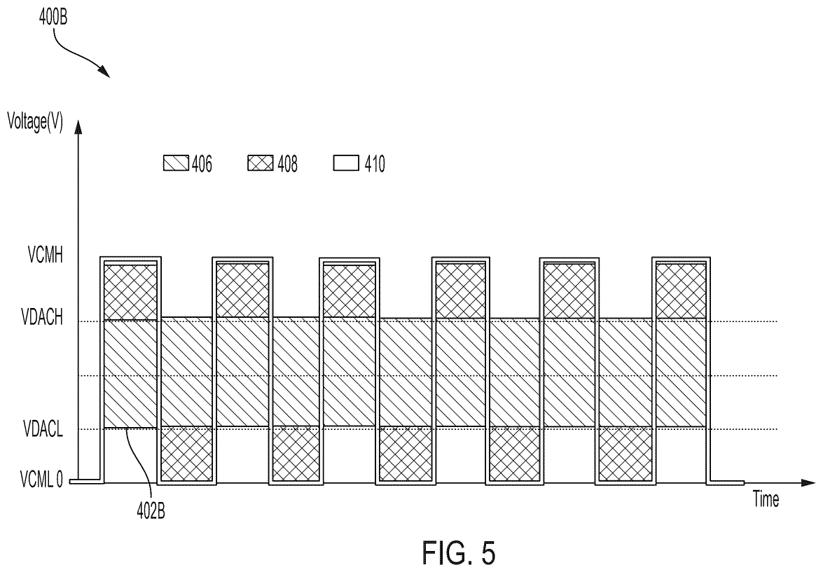

The common mode driver 118 may be configured to apply an average DC voltage across the metasurface array 104 of at or near zero, as described further in connection with FIG. 5. For example, the common-mode driver may periodically invert the polarity of the common-mode voltage. Periodic inversion of the common mode voltage may reduce charge accumulation, which may in turn reduce or prevent long-term degradation of the metasurface elements (e.g., metasurface cells 106). The common mode driver circuit 118 may transmit control signals to the control structure of the pixel sampler 110 by transmitting signals through the second metal interconnect layer 120.

The row driver circuit 122 may be used to select particular rows of the metasurface array 104 for programming. For example, the row driver may send activation signals to the pixel samplers 110. The signals from the row driver may enable the DAC outputs to be written to corresponding metasurface cells 106. For example, the row driver may provide signals to different rows in a time-sequenced manner. As shown in FIG. 1, the row driver circuit 122 may be positioned at the base of the substrate 102 within the substrate 102. In other embodiments, the row driver circuit 122 may be positioned in another layer of the metasurface programming structure 100. For example, the row driver circuit 122 may be fabricated in parallel with the metal interconnect layers (e.g., first metal interconnect layers 116, second metal interconnect layer 120, and/or third metal interconnect layer 124).

The first metal interconnect layers 116, second metal interconnect layer 120, and/or third metal interconnect layer 124 (collectively metal interconnect layers) are used for various signal routing and control operations. For example, signal routing and control operations have been described above for signals generated by the DACs 114, common mode driver circuit 118, and row driver circuit 122. For example, the first metal interconnect layers 116 and third metal interconnect layer 124 may be, used for high-speed signal distribution. The first metal interconnect layers 116 and third metal interconnect layer 124 may be coupled (e.g., electrically coupled) to individual pixel samplers 110. The routing architecture of the metal interconnect layers may be configured such that signals are delivered with reduced or minimal delay and/or interference. The routing architecture of the metal interconnect layers may be additionally or alternatively configured to improve or optimize the performance of the metasurface programming structure 100. As shown in FIG. 1, the metal interconnect layers are positioned between the metasurface array 104 and the substrate 102.

The substrate 102 may comprise a semiconductor substrate. For example, the substrate may comprise silicon (e.g., one or more bulk silicon layers, polysilicon layers, silicon-on-oxide layers, and/or other layers), silicon nitride, and/or III-V semiconductor materials (such as gallium nitride). In some embodiments, substrate 102 may comprise other materials. For example, the substrate may include optical materials, such as glass, sapphire, or other materials.

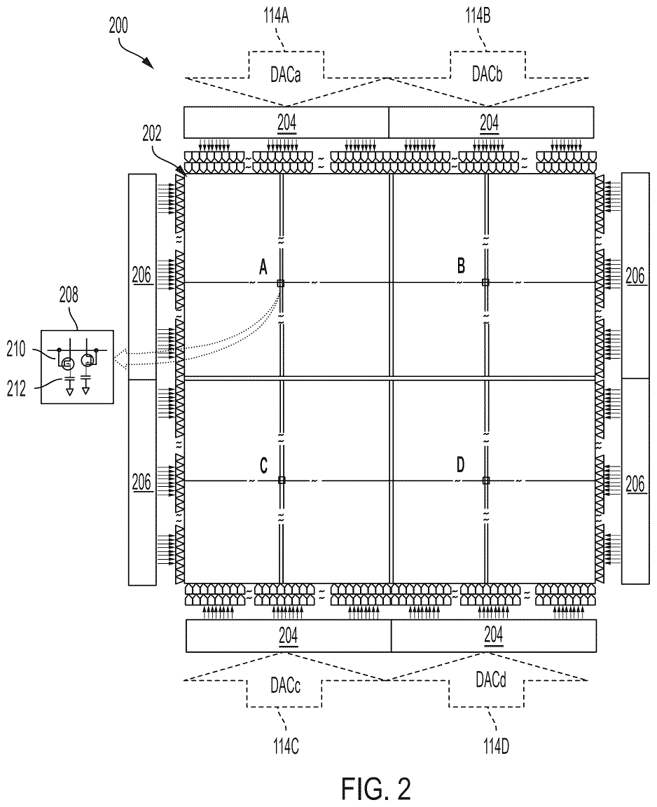

FIG. 2 shows a direct-modulated non-coherent optical vector matrix multiplier 200, according to a non-limiting embodiment of the present technology. The optical vector matrix multiplier 200 includes a metasurface matrix 202, a plurality of DAC arrays 204, and a plurality of row driver circuit arrays 206. In the illustrated embodiment of FIG. 2, the metasurface matrix 202 is partitioned into four independently controlled regions labeled A, B, C, and D. Each partitioned region of the metasurface matrix 202 includes a common mode driver 208. The common mode driver 208 includes a transistor 210 and a capacitor 212.

In various embodiments, the metasurface comprises an N×M array of metasurface cells. In some embodiments, N and M are each an integer value between approximately 64 and 4096. In some embodiments, N may be equal to M. For example, the metasurface may comprise a 1024×1024 array of metasurface cells. In other embodiments, N is not equal to M. For example, the metasurface array may comprise a 2048×4096 array of metasurface cells, or another configuration.

Each region (e.g., A, B, C, D) contains an array of metasurface cells that may be voltage-controlled for dynamic optical modulation. The metasurface cells may be configured as described for the metasurface cells 106 described in connection with FIG. 1.

Providing a metasurface having independently controlled metasurface regions (e.g., A, B, C, and D) may provide improved scalability and/or signal integrity. By providing the metasurface matrix 202 partitioned into separate regions, the system may reduce parasitic capacitance, improve signal propagation, and/or minimize crosstalk between adjacent sections. Furthermore, providing the partitioned regions enables modular architecture of the metasurface matrix 202. For example, the metasurface matrix 202 may be scaled to metasurfaces of varying sizes and configurations, made up with different numbers of the independent regions. For example, a metasurface may include a 3×3 arrangement of nine regions, and 4×4 arrangement of 16 regions, among other configurations.

The DAC arrays 204 may receive digital input signals and convert them into analog voltage outputs. The DAC outputs may be applied to individual metasurface cells. The DAC arrays 204 include a plurality of DACs, which may be configured like the DACs 114 described in connection with FIG. 1. As shown, the DAC arrays 204 are positioned along top and bottom edges of the metasurface matrix 202. In some embodiments, the DACs may be arranged in different locations, such as on other edges of the matrix, below or above the matrix, or arranged on another substrate.

Each DAC array 204 is subdivided into sections corresponding to the four metasurface regions, labeled DACa, DACb, DACc, and DACd, where the DAC regions correspond to metasurface region A, B, C, and D, respectively. DAC regions may send control signals simultaneously. For example, each DAC region may send control signals to respective metasurface regions at approximately the same time. In other embodiments, the DAC regions send control signal at different times. For example, DACa may send signals to metasurface region A while DACb sends no signals to metasurface region B. The illustrated system architecture 200 provides dedicated and synchronized voltage control for each quadrant (e.g., section) individually.

In some embodiments, two or more rows may be written (e.g., two, four, eight, 16, 32, 64, intermediate numbers or rows, or greater number of rows). For example, each of the two or more rows may be written independently and/or simultaneously. The system may include corresponding programming circuits (e.g., including DACs, row drivers, etc.) as described herein to perform the writing of the two or more cells. For example, the system may include two of the DAC arrays 204 to write two or more rows independently and/or simultaneously. Writing two or more rows may reduce a frame update time, increasing the efficiency of the system. The reduction may be proportional to number of rows that are written individually or simultaneously.

The row driver arrays may be configured to select specific rows for programming. The row driver arrays 206 may activate row-enable signals sequentially, allowing the DAC arrays 204 to apply voltages to the selected metasurface cells in a row-by-row fashion. As such, the row driver may cause writing to be performed (for each region) for only one row of the metasurface matrix at a time, reducing or preventing overlapping signals and/or reducing or minimizing interference. The row driver arrays are shown along the left and right edges of the matrix. The row driver arrays include a plurality of row driver circuits. The row driver circuits may be configured like the row driver circuit 122 described in connection with FIG. 1.

In the illustrated embodiment, the optical matrix multiplier 200 performs high-speed data write mechanisms using GHz-speed voltage updates across the metasurface matrix 202. For example, the optical matrix multiplier 200 may operate with a 1 GHz clock (CLK) that provides a timing reference for controlling the data conversion and the programming process. The system operates the row drivers 206 and the DAC arrays 204 in synchrony such that programming occurs with precise timing.

A common mode voltage driver 208 illustrated in the center of each quadrant maintains an average DC voltage across each metasurface cell at or near zero. The common mode voltage driver causes a periodic polarity inversion of the common-mode voltage to prevent charge buildup and/or mitigate device degradation over time. The common mode driver 208 may be configured like the common mode driver circuit 118 described in connection with FIG. 1.

The depicted common mode driver 208 includes transistors 210 and capacitors 212. As shown, the common mode driver 208 include two transistors 210 and two capacitors 212, but any number (e.g., 1, 3, 4, 6, 8, 10) of transistors 210 and/or capacitors 212 may make up the common mode driver 208. Though a transistor 210 is shown, other switch-based electrical structures may alternatively be used. Furthermore, transistors described herein may include field effect transistors (FETs) such as metal oxide FETs (MOSFETs), or other types of transistors. Furthermore, transistors may be n-channel or p-channel, and may be configured to operate in depletion mode or enhancement mode.

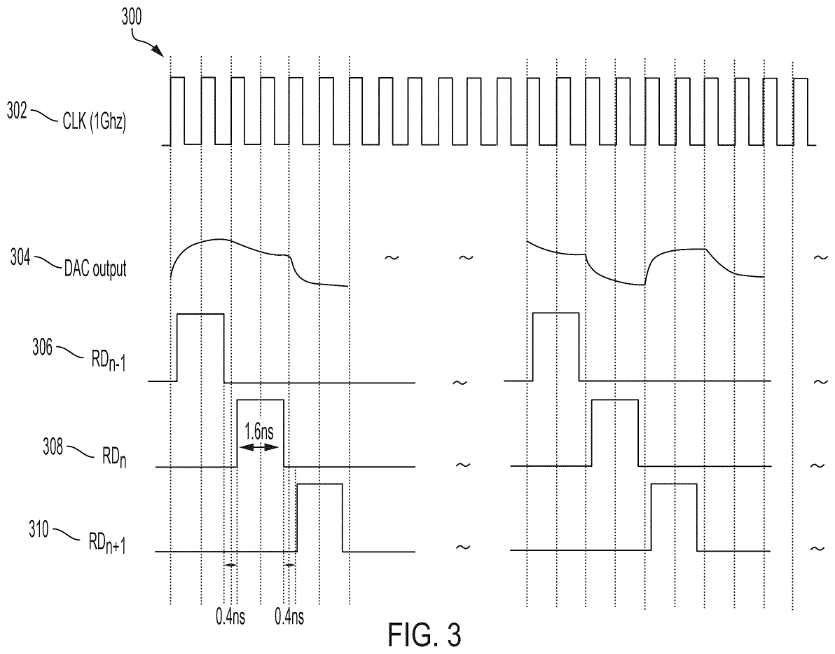

FIG. 3 is a timing diagram 300 for high-speed row-by-row programming. FIG. 3 shows DAC output synchronized with row-enable signals, according to a non-limiting embodiment of the present technology. The timing diagram 300 may illustrate operations of the optical vector matrix multiplier 200 described in connection with FIG. 2. The timing diagram 300 illustrates the sequential activation of row drivers (RD) and the corresponding DAC output waveform 302. As described above, the system may apply DAC outputs to rows using the row signals, in order to update voltage levels of respective metasurface cells.

The DAC output 302 transitions in synchronization with the row driver signals (RDₙ₋₁ 306, RD₁ 308, RDₙ₊₁ 308) to apply voltages to targeted metasurface cells. Each row driver (e.g., row driver circuit 122) provides a pulse configured to perform the sample-and-hold operation for the corresponding row of metasurface cells. The row pulse allows the DAC (e.g., DACs 114) to write a desired voltage level to one or more cells. The RD₁ signal represents the enable signal for a specific row, while RDₙ₋₁ and RDₙ₊₁ correspond to the previous and next rows in the sequence, respectively. The timing diagram 300 shows that each row enable pulse (e.g., for an independent region) may be non-overlapping. The non-overlapping row enable pulses may write rows such that that only one row (e.g., per independent region) is written (e.g., for particular DAC, DAC bank, or region) at a time. As described above, multiple DACs, multiple DACs, or multiple regions may be used to write multiple rows individually or simultaneously. Writing one row at a time per DAC, DAC bank, or region may reduce or prevent conflicts, interference, and/or crosstalk between adjacent rows of the region.

As shown, the DAC output 304 transitions smoothly when a row driver is activated as the capacitors (e.g., first-type capacitors 108, second-type capacitors 112, capacitor 212) are charged until the voltage level stabilizes. After the voltage stabilizes, a subsequent update cycle may begin. In the illustrated example, the duration of each row enable pulse may be 1.6 ns, which corresponds to the time used by the DAC to apply a voltage update to a row of metasurface cells. In other embodiments, the row enable pulse is approximately 0.5 to 2.5 ns (e.g., 1.0-2.0 ns). The timing diagram 300 shows an example interval between consecutive row enable pulses as approximately 0.4 ns. In other embodiments, the interval between consecutive row enable pulses is approximately 0.2 to 0.8 ns (e.g., 0.3-0.5 ns).

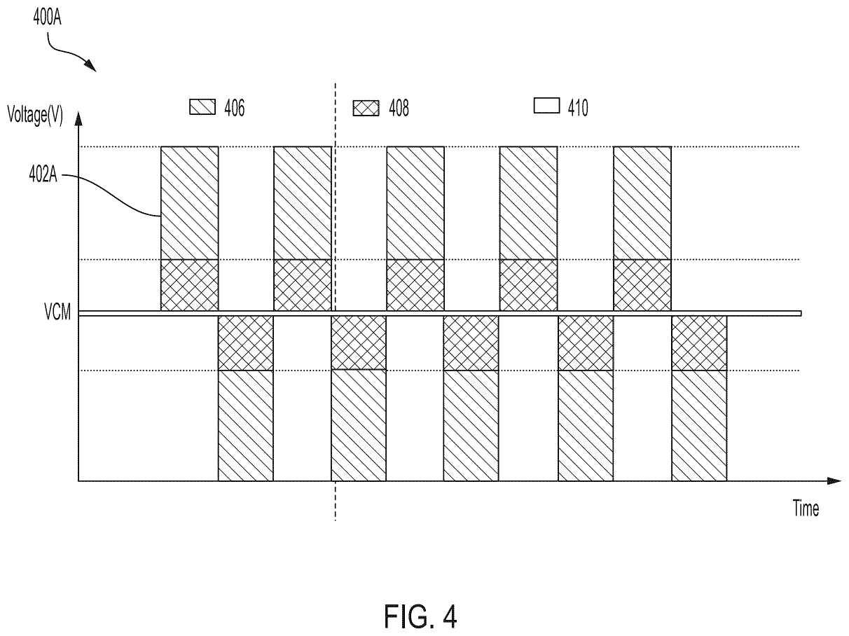

FIG. 4 is a graph 400A showing voltage values of DAC output and common-mode voltage, according to a non-limiting embodiment of the present technology. FIG. 4 shows how a common mode voltage may be applied to metasurface cells, according to some embodiments. The graph 400A includes measurements for DAC signal 402A comprising a DAC output effective region 406 and a DAC output ineffective region 408, and a common mode voltage 410. The graph 400A may depict voltage values of the optical vector matrix multiplier 200 described in connection with FIG. 2.

FIG. 4 shows an embodiment in which the common-mode voltage (VCM) is maintained at a constant voltage (e.g., between 2 and 15 volts (V)). To maintain an average voltage drop of zero across metasurface cells, the system may switch the DAC output (e.g., DAC output effective region 406 and DAC output ineffective region 408) polarity periodically with regard to the common mode voltage 410. However, due to the high-speed nature of the system and lower voltage tolerance for the devices at deep submicron technologies, it may be challenging to change the polarity of the DAC output. Moreover, switching the DAC output may double the DAC output voltage swing (e.g., between 4 and 30 V for a common mode voltage between 2 and 15 V), which increases the cost and complexity of the DAC.

FIG. 5 is a graph 400B showing voltage values of DAC output and common mode voltage using an alternative approach for common mode voltage switching with periodic polarity inversion, according to a non-limiting embodiment of the present technology. FIG. 5 shows how an improved common mode voltage may be applied to metasurface cells to reduce system cost and complexity, according to some embodiments. The graph 400B includes measurements for a DAC signal 402B comprising a DAC output effective region 406 and a DAC output ineffective region 408, and a common mode voltage 410. The graph 400B may depict voltage values of the optical vector matrix multiplier 200 described in connection with FIG. 2.

As shown in FIG. 5, the common-mode voltage 410 is toggled between a common mode high voltage (VCMH) and a common mode low voltage (VCML). In contrast to the embodiment described in the connection with FIG. 4, the polarity of the common mode voltage 410 is changed periodically. Applying a dynamic common mode voltage may simplify the design of high-speed DACs, thus reducing system cost and complexity. System complexity may be reduced because the DAC output voltage swing may be half what would be used in with a constant common mode voltage. For example, the common mode voltage 410 may be toggled between a VCML of 0 V and a VCHM between 1 and 15 V. In some embodiments, the VCML may be a non-zero positive value instead of zero. In other embodiments, the VCML may be a negative value. As shown in FIG. 5, the system may switch the DAC output (e.g., DAC output effective region 406 and DAC output ineffective region 408) polarity periodically, synchronized with the common mode voltage 410. The common mode signal may reduce ionic drift or improve alignment dynamics of a metasurface cell (e.g., alignment of the dielectric of the cell, which may be a liquid crystal, as described below).

In some embodiments, another time varied signal may be used as the common mode signal. The common mode signal may comprise another oscillating signal, such as an AC signal. Examples of the common mode signal include sinusoidal or multi-harmonic drive waveforms applied to the common electrode. The common mode signal may also be applied using frequency-multiplexed addressing. For example, different rows may be driven at distinguishable carrier frequencies. The common mode signal may also be applied using pulse-width modulation (PWM). For example, an effective voltage is set by duty cycle rather than amplitude. PWM may be used to drive dielectric of a metasurface cell (e.g., a liquid crystal).

Using one or more of the DAC and common mode signals described above, a DAC may program he metasurface cells of a column in a time-multiplexed fashion. When the DAC writes to a specific metasurface cell, the associated transmission gate turns on so that the DAC may charge the hold capacitor to the programmed voltage. The transmission gate may comprise a pair of complementary NMOS and PMOS switches. When the DAC is assigned to program other cells, the transmission gate turns off so that the hold capacitor may hold the charge and, maintain the voltage across the metasurface cell. However, due to the leakages on the switches caused by physical properties or other effects on the cell and circuitry, the charge may gradually be depleted. As the charge depletes, a metasurface cell may ultimately fail to maintain a desired voltage across the cell. Since it is desirable to have a longer hold time (e.g., to reduce refreshing), the system may use the DACs to write the same value again before the charge is depleted too much. This refresh process increases the power consumption and reduces the system computation performance. Accordingly, the inventors have recognized and appreciated that providing a cell with improved low switch leakage (and thus improved voltage maintenance) provides improved system performance.

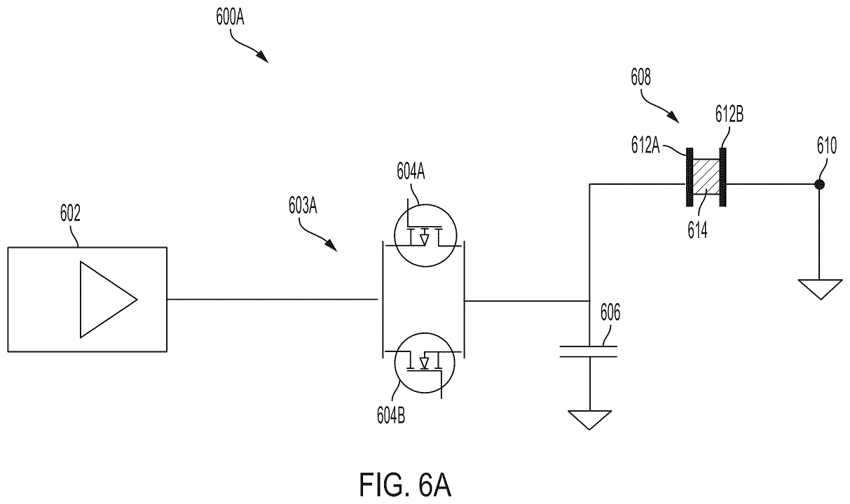

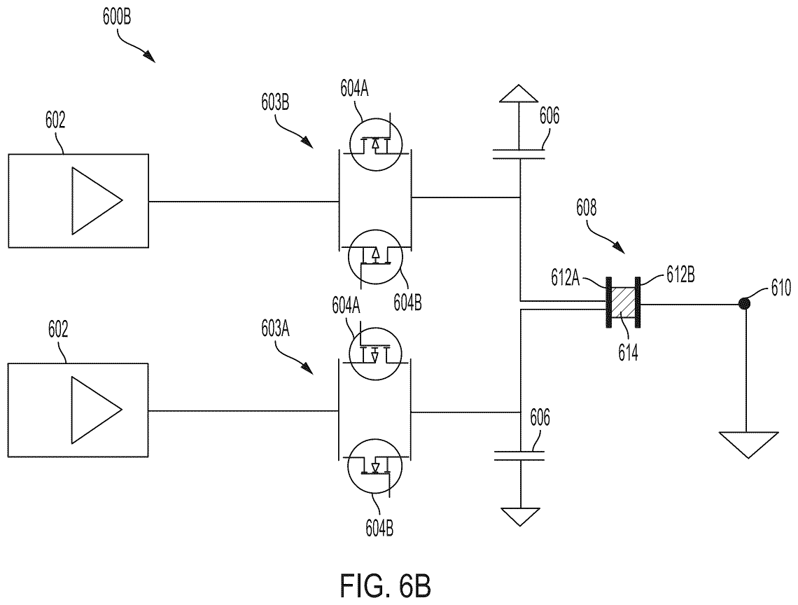

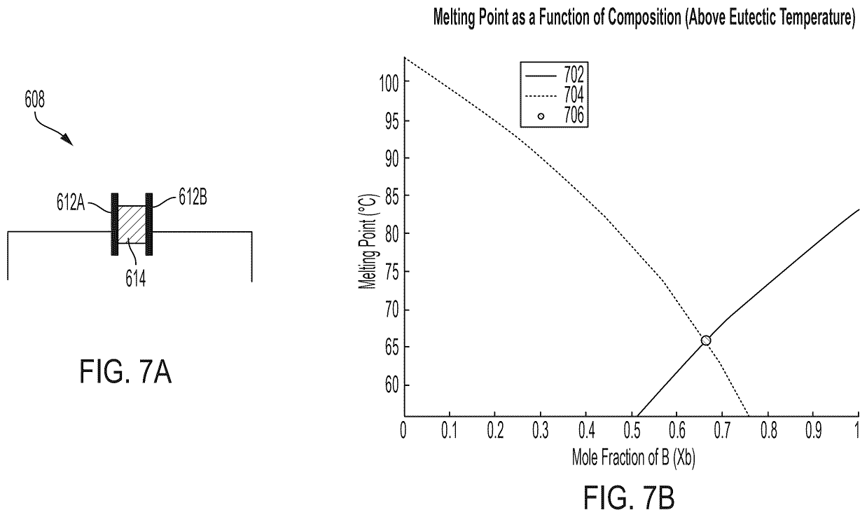

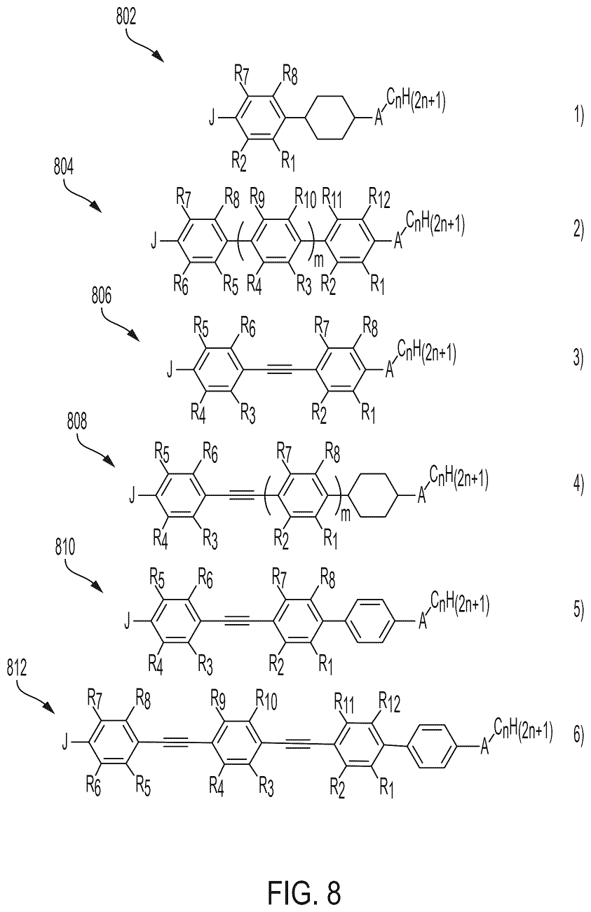

FIG. 6A is a circuit 600A including a metasurface cell, according to a non-limiting embodiment of the present technology. The example circuit 600A includes a first programming circuit 603A, a hold capacitor 606, a metasurface cell 608, and a node 610. First programming circuit 603A includes a DAC 602, and first and second transistors 604A and 604B. First programming circuit 603A is configured to apply a programming value to the metasurface cell 608, as described above. In some embodiments, a common mode signal (as described above) may be applied at node 610. The metasurface cell 608 includes a first and second resonator 612A, 612B (collectively resonators 612) with a dielectric material 614 disposed between the resonators, further described in connection with FIG. 7A and FIG. 8.

The DAC 602 (which may be configured as a DAC 114 described above) generates an analog voltage that is applied to the metasurface cell 608 (e.g., metasurface cell 106) through a transmission gate formed by the first and second transistors 604A and 604B. Each of the first and second transistors 604A and 604B may receive a respective control signal. In various embodiments, one of the first and second transistors 604A and 604B comprises an NMOS and the other comprises PMOS transistor. In some embodiments, each transistor may be NMOS or each may be NMOS, or other types of transistors may be used. The hold capacitor 606 (e.g., first-type capacitors 108) may retain the programmed voltage after the transmission gate is turned off. Retaining the programmed voltage may ensure that the metasurface cell 608 maintains its optical state over a desired period (e.g., until a refresh time or reprogramming time).

In some embodiments, the control signals applied to first and second transistors 604A and 604B may be set to high and low logic levels, respectively, such that the gate-source voltage (Vgs) of both transistors remains near or at zero when the switches are off. Such signals may result in charge leakage due to small transmission that may be present when the gate-source voltage is near zero. In contrast, in some embodiments, subthreshold biasing signals may be applied to the first and second transistors 604A and 604B. In applying the subthreshold biasing signals, Vgs may be applied less than 0 for the NMOS transistor and Vgs may be applied greater than 0 for the PMOS transistor when the switches are to be turned off. By performing such subthreshold biasing, the programming circuit 603A may reduce leakage currents, improving voltage retention on the hold capacitor 606. In various embodiments, the subthreshold biasing technique reduces leakage by a factor of 10, 100, or more.

FIG. 6B is another circuit 600B including a metasurface cell, according to a non-limiting embodiment of the present technology. The example circuit 600B includes a first programming circuit 603A, a second programming circuit 603B, two hold capacitors 606, a metasurface cell 608, and a node 610. The first programming circuit 603A and the second programming circuit 630B each include a DAC 602 and first and second transistors 604A, 604B. The first and second programming circuits 603A, 603B may each be configured to apply a programming value to at least a portion of the metasurface cell 608, in the manner described above with respect to FIG. 6A. In some embodiments, a common mode signal (as described above) may be applied at node 610. The first and second programming circuit 630A, 630B depicted are jointly connected to the metasurface cell 608. The metasurface cell 608 includes a first and second resonator 612A, 612B (collectively resonators 612) with a dielectric material 614 disposed between the resonators, further described in connection with FIG. 7A and FIG. 8.

The components of the circuit 600B may be configured like the circuit 600A described in connection with FIG. 6A. For example, each DAC 602 (e.g., DACs 114) may generate and apply an analog voltage the metasurface cell 608 (e.g., metasurface cell 106) by applying the analog voltage to a respective transmission gate to which they are coupled. The analog voltage applied by the DAC 602 to the first transmission gate is stored in a different hold capacitor 606 than the analog voltage applied by the DAC 602 to the second transmission gate. The analog voltages stored in both hold capacitors 606 are transmitted to the metasurface cell 608 as shown.

A metasurface cell may comprise two or more portions (e.g., two or more portions of dielectric material). The two or more portions of the cell may be arranged in a repeating pattern, such as a tessellation. Each of first programming circuit 603A and second programming circuit 603B may program a voltage value to a different portion of the cell. By applying different voltage values to different portions of the cell, the optical properties (e.g., the complex refractivity) of the cell may be adjusted. In some embodiments, two or more programming circuits are coupled with respective cells.

In some embodiments, a system may include three, four, or more programming circuits coupled with respective metasurface cells. Each such programming circuit may include a respective DAC. Each such programming circuit may be similar to the first and second programming circuits 603A and 603B described above. For example, a cell may include three or more portions, and there may be three or more corresponding programming circuits similar to the first and second programming circuits 603A and 603B described above. In some embodiments, a third voltage or a third and fourth voltage may be applied (e.g., by respective programming circuits) to respective cells to provide greater variations of optical properties of the cell (e.g., to control, phase, reflectivity, one or more orthogonal polarization states).

FIG. 7A is the metasurface cell (e.g., cell 608 of FIGS. 6A-6B). As shown in FIG. 7A, cell 608 may include a dielectric material 614 between two resonators 612, according to a non-limiting embodiment of the present technology. The dielectric material may comprise a liquid crystal. Examples of the dielectric material 614 are discussed further in connection with FIG. 8.

In some embodiments, a metasurface cell may include two or more dielectric layers forming a multilayer dielectric stack (e.g., a multilayer liquid crystal stack). The two or more dielectric layers may be adjacent, or may be interleaved between resonators. Two or more programming to drive such a multilayer, e.g., to provide different optical properties at different heights of the metasurface array.

FIG. 7B is a graph showing liquidus/solidus lines (estimated Tₘᵢₓ) corresponding to Xₐ(solid line) and X_{b} (dashed line), according to some embodiments described herein. The Eutectic point is shown as the intersection (circle), according to a non-limiting embodiment of the present technology.

The phase diagram shows the melting point behavior of a binary liquid crystal mixture as a function of composition above the eutectic temperature. The graph plots the liquidus and solidus lines corresponding to two distinct molecular species, Component A (Xₐ) and Component B (X_{b}), with their respective mole fractions. The solid line represents the melting point of Component A as a function of its mole fraction. The dashed line represents the melting point of Component B as a function of its mole fraction. The circle at the intersection of these two curves denotes the eutectic point. The Eutectic point is the lowest temperature at which the specific composition of the mixture remains in a liquid phase before solidifying.

Accordingly, the eutectic point represents a composition of the binary mixture at which the liquid crystal formulation achieves a minimum melting temperature, which may be used for the development of high-birefringence liquid crystal mixtures. High-birefringence liquid crystal mixtures may be used in a metasurface in optical computing due to the ability to maintain a stable nematic phase over a broad temperature range. The eutectic composition may ensure that the liquid crystal material remains in a functional phase at lower temperatures than either of its pure components, preventing premature crystallization that could degrade optical performance.

The temperature behavior may be estimated using Van't Hoff's equation, which models the melting temperature (Tₘᵢₓ) of a multi-component mixture as a function of the enthalpies of fusion and mole fractions of individual components. In this formulation, the equilibrium melting point is derived under the assumption of ideal mixing, where each component is completely miscible in both the solid and liquid states, and intermediate phase transitions (e.g., smectic, cholesteric, and/or other phases) do not interfere with the eutectic behavior.

The mixture melting point, Tₘᵢₓ, can be estimated where Xₖ is the mole fraction of the k-component,

$$Δ {H}_{m}^{k}$$

is the melting enthalpy,

$${T}_{m}^{k}$$

is the melting temperature of the pure k-component, and R is the gas constant.

$$ln {X}_{k} = - \frac{Δ {H}_{m}^{k}}{R} ( \frac{1}{{T}_{m i x}} - \frac{1}{{T}_{m}^{k}} ) \qquad Equation 1$$

$${\sum }_{k = 1}^{n} {X}_{k} = 1 \qquad Equation 2$$

FIG. 7B shows an estimation of the eutectic point for a simple binary mixture of components having

$${T}_{m}^{a} = 83.1 C , {T}_{m}^{b} = 103.2 C , Δ {H}_{m}^{a} = 24 Kj / mol , Δ {H}_{m}^{b} = 30.92 Kj / mol .$$

At temperatures above the liquidus/solidus lines the mixture is entirely liquid. Similarly, at temperatures below the lines, the mixture is entirely solid. The eutectic point is estimated as the lowest temperature at which the mixture Xₐ+X_{b}=1 (the intersection of Xₐ and X_{b} lines).

Above the eutectic temperature, the system remains in a fully liquid state. Below the eutectic temperature, the components begin to solidify according to their respective phase diagrams, but the eutectic composition crystallizes as a homogeneous solid. The composition of the liquid crystal mixture may be adjusted in terms of the relative mole fractions of the constituent mesogens to select a target melting point, target birefringence, and/or target viscosity, according to the specific usage application in high-performance optical modulation for optical computing. The same principles extend beyond binary mixtures and may be generalized to multi-component eutectic systems.

Practical high-birefringence nematic liquid crystal mixtures are typically not composed of only two components. As a generalization, the more components that make up a mixture, the lower it's freezing temperature will be. In the case of mixtures with n components, the Van't Hoff equations may be used to iteratively minimize Tₘᵢₓ and determine the mol fraction of each component at this minimum temperature, which is taken to be the eutectic point. It is important to note that this analysis gives a useful starting point for preparing a eutectic mixture, but is not necessarily indicative of exactly the final mixture that yields best results due to deviation from ideal mixture behavior.

Several examples of individual liquid crystal mesogenic molecular structures (LC Singles) from which high-birefringence mixtures (generally accepted as Δnₘᵢₓ>0.3) may be formulated, are given in FIG. 8 (structures 1-6). Although many other physical parameters are useful for the realization of practically useful liquid crystal mixtures, writing in general terms, where

$${\sum }_{k = 1}^{n} {X}_{k} = 1 ,$$

the mole fractions of a mixture having n components the components may be used, along with known values for Δn^{k}, in a simple linear combination to estimate Δnₘᵢₓ using

$${\sum }_{k = 1}^{n} {X}_{k} ( Δ {n}^{k} ( ω ) ) = Δ {n}_{m i x} ( ω ) \qquad Equation 3$$

In one possible embodiment, the liquid crystal mixture employed herein contains any or all of the above base structures (1-6), where: A equals CH₂, O, N, or S; R₁-R12 equals CₙH₍₂ₙ₊₁₎, H, F, Cl, SCₙH₍₂ₙ₊₁₎, or Br; and J equals NCS, F, CN, CF₃, OCF₃, Br, Cl, or H. In this case R₁-R₁₂, may be the same or different in the same structure, and they may be the same or different among disparate and/or homologous structures. Generally, there will be structures or groups of structures in which R₁-R₁₂ are all H, and also examples in which only one or two R-groups are replaced by F and/or Cl, alkyl, etc.

The common descriptive name for Structure 1 is: cyclohexyl-phenyl. It consists of a cyclohexyl ring and a phenyl ring attached together, and includes all possible combinations of A, J, Cₙ, and R₁-R₈.

The common descriptive name for Structure 2 is: a biphenyl when m=0, a terphenyl when m=1, and a quaterphenyl when m=2, with multiple phenyl rings attached together by intermediate single bonds and includes all possible combinations of A, J, Cₙ, and R₁-R₁₂.

The common descriptive name for Structure 3 is: a tolane. A tolane at its most basic form consists of phenyl rings at either end of a triple bond and includes all possible combinations of A, J, Cₙ, and R₁-R₈.

The common descriptive name for Structure 4 is: a cyclohexyl-tolane. This simply adds a cyclcohexyl ring to either side of the base tolane when m=1, and may be extended to the phenyl tolane structure (5) when m=2 (e.g., cyclohexyl-phenyl tolane) and includes all possible combinations of A, J, Cₙ, and R₁-R₈.

The common descriptive name for Structure 5 is: a phenyl-tolane. A phenyl ring is added to the base tolane structure and includes all possible combinations of A, J, Cₙ, and R₁-R₈.

The common descriptive name for Structure 6 is: a phenyl-bis-tolane. It places triple-bonds between multiple phenyl groups and includes all possible combinations of A, J, Cₙ, and R₁-R12.

Added for descriptive purposes: (not limiting the possible embodiments covered here), the number of carbons in the flexible carbon “tail” attached to A commonly varies between n=1 and n=7: n=1 methyl; n=2 ethyl; n=3 propyl; n=4 butyl, etc. This may vary with groups of structures in order to modify melting point.

In various embodiments, the LC material is configured to provide tunability of one or more electromagnetic properties including refractive indices (ordinary index nₒ, extraordinary index nₑ), birefringence (Delta n=nₑ−nₒ), absorption, dichroism, and/or dielectric properties (e.g., dielectric anisotropy Delta epsilon), in one or more spectral bands. Non-limiting spectral bands include visible, near-infrared (including telecommunications wavelengths such as around 1.3 um and 1.55 um), mid-infrared, long-wave infrared, terahertz, millimeter-wave, microwave, and radio-frequency bands.

In various embodiments, high-birefringence LC single compounds (“LC singles”) include mesogenic molecules having an elongate rigid core that provides high electronic polarizability anisotropy. The rigid core may comprise two or more cyclic units selected from a group consisting of: aryl rings (e.g., phenyl), fused aryl systems (e.g., naphthyl), heteroaryl rings (e.g., pyridyl, pyrimidinyl, thiophenyl, thienothiophenyl, benzothiazolyl), and cycloaliphatic rings (e.g., cyclohexyl, bicyclohexyl), and combinations thereof.

The cyclic units of the rigid core may be connected by one or more linking groups selected from a group consisting of: a single bond; ethynyl (C≡C); diacetylene (C≡C—C≡C); vinylene (CH═CH); azo (N═N); imine (CH═N); ester; ether; thioether; carbonyl-containing linkers; and combinations thereof. In some embodiments, one or more linking groups are configured to increase pi-conjugation length (e.g., ethynyl or diacetylene linkers) to increase birefringence, while other groups are configured to reduce melting point, suppress smectic ordering, or reduce viscosity. In some embodiments, the rigid core optionally includes one or more heteroatoms (e.g., N, O, S, Se) within the ring system and/or within a linker, and optionally includes one or more fused-ring or sulfur-containing motifs (e.g., benzothiophene or dibenzothiophene cores), which may increase polarizability and birefringence.

In various embodiments, LC singles include one or more flexible terminal groups (also referred to as “tails”) and one or more polar end groups. The tails may be independently selected from a group consisting of: C1-C20 alkyl, C2-C20 alkenyl, C2-C20 alkynyl, C1-C20 alkoxy, C1-C20 thioalkyl, and optionally fluorinated analogs thereof (e.g., partially or fully fluorinated alkyl or alkoxy). The tails may be linear, branched, cyclic, or contain one or more heteroatoms.

Non-limiting examples of polar end groups include isothiocyanate (NCS), nitrile (CN), thiocyanate (SCN), halogens (F, Cl, Br, I), trifluoromethyl (CF₃), trifluoromethoxy (OCF₃), difluoromethoxy (OCHF₂), sulfonyl-containing groups, and other electron-withdrawing groups capable of providing a permanent dipole moment and/or modifying dielectric anisotropy.

In various embodiments, LC singles include lateral substituents (on one or more rings of the rigid core) selected from a group consisting of: halogens, alkyl, alkoxy, thioalkyl, cyano, trifluoromethyl, and combinations thereof. Lateral substitution patterns may be configured to tune melting point, clearing point, dielectric anisotropy, elastic constants, viscosity, and/or to suppress smectic phases and broaden the nematic range.

The illustrative Structures (1-6) shown in FIG. 8 and their described variants are intended as examples and are not intended to be limiting. In various embodiments, the LC material includes Structures (1-6), derivatives thereof, and/or structurally related mesogens that share one or more of the following: (i) two or more cyclic units; (ii) one or more ethynyl or diacetylene linkers; (iii) one or more polar end groups; and (iv) one or more flexible tails. Accordingly, in one possible embodiment, and without limiting other embodiments, for Structures (1-6): A may be selected from a group consisting of: CH2, O, S, Se, NR (where R is H or an alkyl), carbonyl-containing linkers, and combinations thereof, R1-R12 may be independently selected from a group consisting of: H, halogens, C1-C20 alkyl, C2-C20 alkenyl, C2-C20 alkynyl, C1-C20 alkoxy, C1-C20 thioalkyl, cyano, trifluoromethyl, and optionally fluorinated analogs thereof, and J may be selected from a group consisting of: NCS, CN, SCN, halogens, CF₃, OCF3, and other polar terminal groups. In this context, R1-R12 may be the same or different within a given structure and may be the same or different among disparate, homologous, and/or isomeric structures. The number of carbon atoms in one or more flexible tails may be, for example, from n=1 to n=20. In some embodiments, one or more of the rings shown in Structures (1-6) may be replaced by a heteroaryl ring or a fused ring system, and/or one or more phenyl rings may be replaced by a cycloaliphatic ring, provided that the resulting molecule exhibits a liquid crystalline phase in at least a portion of the operating temperature range.

In various embodiments, the LC material is formulated as a eutectic mixture comprising multiple LC singles configured to provide a desired combination of melting point, clearing point, birefringence, dielectric anisotropy, elastic constants, viscosity, resistivity, and stability. In some embodiments, high-birefringence LC singles are blended with one or more low-viscosity components (diluents) such as nonpolar or weakly polar cycloaliphatic mesogens (e.g., bicyclohexyl-based mesogens) to reduce rotational viscosity and/or to improve response time while maintaining a target birefringence.

In some embodiments, mixtures include combinations of different polar end groups (e.g., nitrile-terminated singles combined with isothiocyanate-terminated singles) to tune dielectric anisotropy, suppress aggregation effects, and/or balance viscosity and optical performance.

In some embodiments, one or more hydrogen atoms in any LC single compound may be replaced with deuterium (D) or another isotope to improve photochemical stability, adjust absorption, and/or modify physical properties. In some embodiments, stereoisomers, regioisomers, conformational isomers, and/or tautomers of any LC single compound are included within the scope of the LC material.

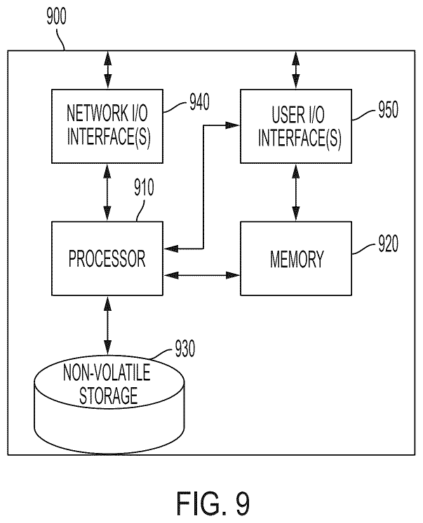

FIG. 9 shows an illustrative implementation of a computer system 900 that may be used in connection with any of the embodiments of the technology described herein (e.g., such as a controller implementing the metasurface programming structure 100 of FIG. 1 and/or the optical vector matrix multiplier 200 of FIG. 2). The computer system 900 includes one or more processors 910 and one or more articles of manufacture that comprise non-transitory computer-readable storage media (e.g., memory 920 and one or more non-volatile storage device 930). The processor 910 may control writing data to and reading data from the memory 920 and the non-volatile storage device 930 in any suitable manner, as the aspects of the technology described herein are not limited to any particular techniques for writing or reading data. To perform any of the functionality described herein (e.g., in connection with control circuitry), the processor 910 may execute one or more processor-executable instructions stored in one or more non-transitory computer-readable storage media (e.g., the memory 920), which may serve as non-transitory computer-readable storage media storing processor-executable instructions for execution by the processor 910.

The computer system 900 may also include a network input/output (I/O) interface 940 via which the computing device may communicate with other computing devices (e.g., over a network), and may also include one or more user I/O interfaces 950, via which the computing device may provide output to and receive input from a user. The user I/O interfaces may include devices such as a keyboard, a mouse, a microphone, a display device (e.g., a monitor or touch screen), speakers, a camera, and/or various other types of I/O devices.

In this respect, it should be appreciated that one implementation of the embodiments described herein comprises at least one computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-described functions of one or more embodiments. The computer-readable medium may be transportable such that the program stored thereon can be loaded onto any computing device to implement aspects of the techniques described herein. In addition, it should be appreciated that the reference to a computer program which, when executed, performs any of the above-described functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques described herein.

It will be apparent that example aspects, as described above, may be implemented in many different forms of software, firmware, and hardware in the implementations illustrated in the figures. Further, certain portions of the implementations may be implemented as a “module” that performs one or more functions. This module may include hardware, such as a processor, an application-specific integrated circuit (ASIC), or a field-programmable gate array (FPGA), or a combination of hardware and software. Such a module may be configured to implement control circuitry as described herein.

The terms “program” or “software” are used herein in a generic sense to refer to any type of computer code or set of computer-executable instructions that can be employed to program a computer or other processor to implement various aspects as described above. Additionally, it should be appreciated that according to one aspect, one or more computer programs that when executed perform methods of the present disclosure need not reside on a single computer or processor but may be distributed in a modular fashion among a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone, a tablet, or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

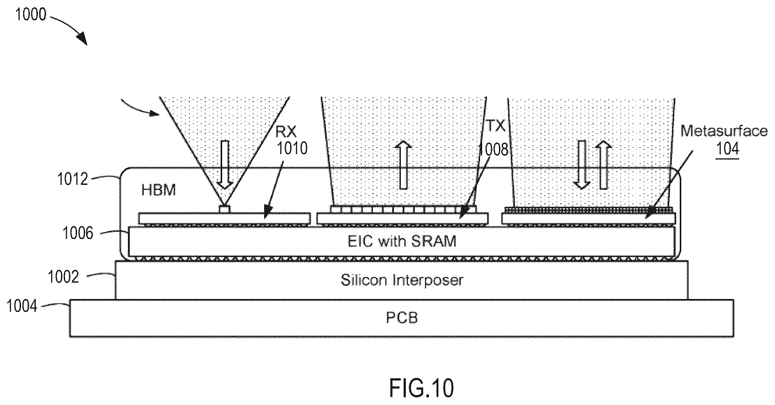

FIG. 10 shows exemplary components of an optical computing system. FIG. 10 illustrates a block diagram of an example implementation of stacked layers 1000 of an optical computing system. The stacked layers 1000 may include the optical vector matrix multiplier 200 of FIG. 2. The illustrated integration of key components, including photonic, optical, and digital elements, within a compact packaging structure, provides high-performance and energy-efficient computation. As illustrated, an optical computing system may include a printed circuit board (PCB) 1004 that is configured to provide foundational physical support (e.g., by physically supporting a metasurface) and electrical support (e.g., by routing electrical signals as part of in operating the metasurface and/or peripheral components). A silicon interposer 1002 is mounted on the PCB 1004. The silicon interposer 1002 provides a communication interface between various photonic and electronic components of the system. The silicon interposer 1002 may, for example, include through-silicon vias (TSVs) to enable high-bandwidth connections between the various layers of the system.

An integrated control circuit 1006 is positioned on the silicon interposer 502. The integrated control circuit 1006 may comprise an ASIC or EIC with integrated SRAM. The integrated control circuit 1006 serves as the central control hub for the system, managing data flow between a silicon photonic transmitter 1008, the metasurface 104, and a silicon photonic receiver 1010. The integrated control circuit 1006 interfaces with a HBM module 1012 via the silicon interposer 1002. A host memory buffer (HBM) module 1012 may be used to store large two-dimensional matrices and/or other data used for vector-matrix multiplication operations. The integration of the HBM module 1012 and integrated control circuit 1006 on the silicon interposer 1002 minimizes physical distances, which reduces latency and energy consumption during memory access.

As illustrated and described herein, the layered architecture of the optical vector matrix multiplier 200 of FIG. 2 provides efficient integration of photonic, optical, and electronic components. The layered architecture shown in FIG. 10 includes co-located and/or co-planar positioning of the integrated control circuit 1006, the silicon photonic transmitter 1008, the metasurface 104, and the silicon photonic receiver 1010. The illustrated and described architecture reduces latency and energy costs, which is especially useful in high-performance computing applications. The combination of advanced packaging techniques, such as TSVs and silicon interposers, with high-performance components ensures that the system is capable of executing complex computations efficiently. The architecture is well-suited for applications in artificial intelligence, neural network inference, and other tasks requiring large-scale matrix-vector operations and/or other linear algebra operations.

In some embodiments, the silicon photonic transmitter 1008 is implemented by a first PIC and the silicon photonic receiver 1010 is implemented by a second PIC, different from the first PIC. Alternatively, the silicon photonic transmitter 1008 and the silicon photonic receiver 1010 may be implemented by and/or included in the same PIC.

The photonic transmitter 1008 may be configured to transmit photons, such as light. For example, the photonic transmitter 1008 may comprise a light source such as a light emitting diode. The light may be directed by the system from the photonic transmitter 1008 to the metasurface. In some embodiments, the photonic transmitter 1008 includes a photonic guide element (e.g., a mirror, a fiber optic, or another photonic guide) configured to direct light from the photonic transmitter 1008 to the metasurface.

The photonic receiver 1010 may be configured to receive photons, such as light. For example, the photonic receiver 1010 may comprise a sensor such as a photodiode, CMOS sensor, CCD sensor. The light may be directed by the system from the metasurface to the photonic receiver 1010. In some embodiments, the photonic receiver 1010 includes a photonic guide element (e.g., a mirror, a fiber optic, or another photonic guide) configured to direct light from the metasurface to the photonic receiver 1010.

Aspects of the present technology provide various benefits. Some have been described already and some are now listed here. It should be appreciated that not all embodiments provide all benefits and that benefits other than those listed may be provided.

Some aspects of the present technology provide optical circuits having high computation capacity at fast processing speeds. Such circuits may be suitable for use in data centers or to operate Artificial Intelligence (AI) models, as examples.

Having described above several aspects of at least one embodiment, it is to be appreciated various alterations, modifications, and improvements will readily occur to those skilled in the art. Such alterations, modifications, and improvements are intended to be an object of this disclosure. Accordingly, the foregoing description and drawings are by way of example only.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Use of ordinal terms such as “first,” “second,” “third,” et cetera, does not by itself connote any priority, precedence, or order of one element over another or the temporal order in which acts of a method are performed. Such terms are used merely as labels to distinguish one element having a certain name from another element having a same name (but for use of the ordinal term) to distinguish the elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. An optical computing device, comprising:
a substrate;
a metasurface array arranged on the substrate, the metasurface array comprising a plurality of metasurface cells; and
circuitry configured to program metasurface cells of the plurality of metasurface cells of the metasurface array.

2. The optical computing device of claim 1,
wherein the plurality of metasurface cells of the metasurface array comprises a first metasurface cell;
wherein the circuitry comprises a first programming circuit configured to apply a first programming value to the first metasurface cell.

3. The optical computing device of claim 2, wherein the first programming circuit comprises:
a first digital-to-analog converter (DAC) configured to generate the first programming value; and
a first transmission gate, comprising a first transistor and a second transistor, the first transmission gate configured to apply the first programming value to the first metasurface cell based on one or more enable signals.

4. The optical computing device of claim 3, wherein:
the circuitry further comprises a row driver configured to generate the one or more enable signals.

5. The optical computing device of claim 3, wherein:
the circuitry is configured to apply subthreshold biasing signals to the first transistor and the second transistor to close the first transmission gate.

6. The optical computing device of claim 3, wherein the circuitry further comprises:
a first hold capacitor, configured to hold the first metasurface cell at the first programming value when the first transmission gate is closed.

7. The optical computing device of claim 2, wherein the circuitry further comprises:
a common mode driver configured to apply a common mode voltage to the first metasurface cell when the first programming circuit applies the first programming value to the first metasurface cell.

8. The optical computing device of claim 7, further comprising:
a second programming circuit, configured to apply a second programming value to the first metasurface cell of the metasurface array.

9. The optical computing device of claim 7, wherein:
the common mode driver is configured to generate the common mode voltage such that the common mode voltage has a periodic signal.

10. The optical computing device of claim 1, wherein:
each metasurface cell of the plurality of metasurface cells of the metasurface array is coupled to the circuitry such that each metasurface cell is coupled to a first programming circuit configured to generate a first cell voltage, a second programming circuit configured to generate a second cell voltage, and a common mode driver configured to generate a time-varied common mode voltage.

11. The optical computing device of claim 1, wherein:
each metasurface cell of the plurality of metasurface cells of the metasurface array is coupled to the circuitry such that each metasurface cell is coupled to a first programming circuit configured to generate a first cell voltage, a second programming circuit configured to generate a second cell voltage, and a third programming circuit configured to generate a third cell voltage.

12. The optical computing device of claim 1, wherein:
each metasurface cell of the plurality of metasurface cells of the metasurface array is associated with a respective row and a respective column; and
the circuitry is configured to program each metasurface cell using a respective row signal and a respective column signal.

13. The optical computing device of claim 1, wherein each metasurface cell of the plurality of metasurface cells of the metasurface array comprises:
a first resonator;
a second resonator; and
a dielectric material disposed between the first resonator and the second resonator.

14. The optical computing device of claim 13, wherein the dielectric material comprises a liquid crystal mixture.

15. A method of controlling optical properties of a metasurface array comprising a plurality of metasurface cells, the method comprising:
selecting a first metasurface cell of the plurality of metasurface cells of the metasurface array;
generating a first programming value; and
applying the first programming value to the first metasurface cell.

16. The method of claim 15, further comprising:
generating a second programming value; and
applying the second programming value to the first metasurface cell.

17. The method of claim 15, wherein generating the first programming value comprises:
generating a first voltage using a first digital-to-analog circuit (DAC); and
applying the first voltage to the first metasurface cell of the plurality of metasurface cells of the metasurface array using a transmission gate comprising a first transistor and a second transistor.

18. The method of claim 17, wherein applying the first voltage to the first metasurface cell using the transmission gate comprises:
applying one or more enable signals to the first transistor and the second transistor using a row driver.

19. The method of claim 15, further comprising:
retaining a programmed voltage using a hold capacitor.

20. The method of claim 16, further comprising:
applying a common mode signal to the first metasurface cell of the plurality of metasurface cells of the metasurface array.

21. An optical computing system, comprising:
an integrated circuit configured to generate first control signals;
an optical computing device coupled to the integrated circuit, comprising:
a metasurface array; and
circuitry configured to program the metasurface array based on the first control signals transmitted by the integrated circuit;
a photonic transmitter configured to transmit first optical signals to the metasurface array; and
a photonic receiver, configured to receive second optical signals from the metasurface array.

22. The optical computing system of claim 21, wherein:
the integrated circuit is further configured to generate second control signals, the photonic transmitter configured to transmit the first optical signals to the metasurface array based on the second control signals; and
the integrated circuit is further configured to perform at least one calculation based on the second optical signals received from the metasurface array by the photonic receiver.

23. The optical computing system of claim 21, further comprising:
a printed circuit board (PCB), wherein the optical computing system is disposed on the PCB; and
an interposer positioned between the integrated circuit and the PCB.

24. The optical computing system of claim 21, wherein:
the metasurface array comprises a plurality of metasurface cells; and
each metasurface cell of the plurality of metasurface cells of the metasurface array is coupled to a first programming circuit of the circuitry, a second programming circuit of the circuitry, and a common mode driver of the circuitry.

25. The optical computing system of claim 21, wherein:
the circuitry configured to program the metasurface array comprises a first DAC and a second DAC, wherein the first and second DACs are configured to write programming values to two or more metasurface cells of the metasurface array simultaneously.
